(19) United States
(12) Patent Application Publication
(10) Pub. No.: US 2023/0253612 A1
(43) Pub. Date: Aug. 10, 2023

(54) SOLID ELECTROLYTE, PREPARING METHOD THEREOF, AND ALL SOLID STATE BATTERY

(71) Applicant: SAMSUNG SDI CO., LTD., Yongin-si (KR)

(72) Inventors: Wonseok CHO, Yongin-si (KR); Sangil HAN, Yongin-si (KR); Kyulin LEE, Yongin-si (KR)

(21) Appl. No.: 18/094,748

(22) Filed: Jan. 9, 2023

(30) Foreign Application Priority Data
Feb. 10, 2022 (KR) 10-2022-0017782

(51) Int. Cl. H01M 10/056; H01M 10/052

(52) U.S. Cl. CPC H01M 10/056; H01M 10/052; H01M 2300/0094

(57) ABSTRACT

A solid electrolyte, a method of preparing the solid electrolyte, and an all-solid-state battery including the solid electrolyte, the solid electrolyte includes a sulfide solid electrolyte particle; and a hydrophobic compound on a surface of the sulfide solid electrolyte particle, wherein the hydrophobic compound includes a fluoroalkyl group substituted with 3 to 13 fluorine groups.

### CROSS-REFERENCE TO RELATED APPLICATION

This application claims priority to and the benefit of Korean Patent Application No. 10-2022-0017782 filed in the Korean Intellectual Property Office on Feb. 10, 2022, the entire contents of which are incorporated herein by reference.

### BACKGROUND

### 1. Field

Embodiments relate to a solid electrolyte, a preparing method thereof, and an all-solid-state battery including the same.

### 2. Description of the Related Art

A portable information device such as a cell phone, a laptop, smart phone, and the like or an electric vehicle has used a rechargeable lithium battery having high energy density and easy portability as a driving power source. Recently, research has been actively conducted to use rechargeable lithium batteries with high energy density as a driving power source or power storage power source for hybrid or electric vehicles.

Commercially available rechargeable lithium batteries typically use an electrolyte solution containing a flammable organic solvent. Thus, such commercially available rechargeable lithium batteries including a flammable organic solvent may raise safety issues such as the possibility of explosion or ignition, when subjected to a crash, penetration, or similar trauma. Accordingly, semi-solid batteries or all-solid-state batteries that do not use an electrolyte solution have been proposed. The term “all-solid-state batteries” among rechargeable lithium batteries refers to batteries made of all solid materials and particularly, refers to batteries that use a solid electrolyte. Such all-solid-state batteries are safe due to no risk of explosion or leakage of the electrolyte solution and the like and thus may be easily manufactured into a thin battery.

In the all-solid-state batteries, a sulfide solid electrolyte having excellent ionic conductivity have generally been used, but such batteries may have a problem of being easily deteriorated by moisture. For example, the sulfide solid electrolyte can react with moisture in the air and may generate toxic hydrogen sulfide (H₂S) gas, thereby changing a structure of the sulfide solid electrolyte. Accordingly, when the sulfide solid electrolyte is exposed to the moisture, it may not only be dangerous, but also the ionic conductivity of the electrolyte may drop sharply, resulting in a failure of performance. Therefore, it is desirable that all-solid-state batteries be manufactured and driven in a moisture-free environment.

### SUMMARY

Embodiments are directed a solid electrolyte having reduced reactivity with moisture and improved structural stability, a method for preparing the same, and an all-solid-state battery including the same.

In an embodiment, a solid electrolyte includes a sulfide solid electrolyte particle and a hydrophobic compound on the surface of the sulfide solid electrolyte particle, wherein the hydrophobic compound contains a fluoroalkyl group substituted with 3 to 13 fluorine groups.

In another embodiment, a method of preparing a solid electrolyte includes dry-mixing a sulfide solid electrolyte particle; and a hydrophobic compound containing a fluoroalkyl group substituted with 3 to 13 fluorine groups, followed by heat-treating the same.

In another embodiment, an all-solid-state battery includes a positive electrode, a negative electrode, and a solid electrolyte layer between the positive electrode and the negative electrode, wherein the positive electrode and/or the solid electrolyte layer includes the aforementioned solid electrolyte.

The solid electrolyte according to the embodiment has low reactivity with moisture, is structurally stable, and exhibits high ionic conductivity. An all-solid-state battery including the same may implement high initial efficiency and cycle-life characteristics.

### BRIEF DESCRIPTION OF THE DRAWINGS

Features will become apparent to those of skill in the art by describing in detail exemplary embodiments with reference to the attached drawings in which:

FIGS. 1 and 2 are cross-sectional views schematically illustrating all-solid-state batteries according to embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

The terminology used herein is used to describe embodiments only, and is not intended to limit the present disclosure. The singular expression includes the plural expression unless the context clearly dictates otherwise.

As used herein, the term “a combination thereof” may refer to a mixture, a laminate, a composite, a copolymer, an alloy, a blend, a reaction product, or the like of constituents.

Herein, it should be understood that terms such as “comprises,” “includes,” or “have” are intended to designate the presence of an embodied feature, number, step, element, or a combination thereof, but such terms do not preclude the possibility of the presence or addition of one or more other features, numbers, steps, elements, or a combination thereof.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, the term “layer” herein includes not only a shape formed on the whole surface when viewed from a plan view, but also a shape formed on a partial surface.

In addition, an average particle diameter or an average size may be measured by methods well known to those skilled in the art. For example, an average particle diameter or an average size may be measured by a particle size analyzer, or may be measured by a transmission electron micrograph or a scanning electron micrograph. Alternatively, it may be possible to obtain an average particle diameter value by measuring sizes using a dynamic light scattering method, performing data analysis, counting the number of particles for each particle size range, and calculating the value from this information. Unless otherwise defined, the average particle diameter refers to a diameter (D50) of particles having a cumulative volume of 50 volume % in the particle size distribution as measured by a particle size analyzer.

Herein, “or” is not to be construed as an exclusive meaning, for example, “A or B” may be construed to include A, B, A+B, or the like.

As used herein, “substituted” in the term “substituted or unsubstituted” refers to replacement of at least one hydrogen by a halogen atom (F, Cl, Br, or I), a hydroxy group, a C1 to C20 alkoxy group, a nitro group, a cyano group, an amine group, an imino group, an azido group, an amidino group, a hydrazino group, a hydrazono group, a carbonyl group, a carbamyl group, a thiol group, an ester group, an ether group, a carboxyl group or a salt thereof, a sulfonic acid group or a salt thereof, a phosphoric acid group or a salt thereof, a C1 to C20 alkyl group, a C2 to C20 alkenyl group, a C2 to C20 alkynyl group, a C6 to C20 aryl group, a C3 to C20 cycloalkyl group, a C3 to C20 cycloalkenyl group, a C3 to C20 cycloalkynyl group, a C2 to C20 heterocycloalkyl group, a C2 to C20 heterocycloalkenyl group, a C2 to C20 heterocycloalkynyl group, a C3 to C20 heteroaryl group, or a combination thereof

Solid Electrolyte

In an implementation, by introducing a specific hydrophobic compound to the surface of the sulfide solid electrolyte particle, a solid electrolyte having reduced reactivity with water and improved stability is provided. Specifically, the solid electrolyte according to an embodiment may include a sulfide solid electrolyte particle and a hydrophobic compound on a surface of the sulfide solid electrolyte particle. The hydrophobic compound may be a compound containing a fluoroalkyl group substituted with 3 to 13 fluorine groups (e.g., fluorine atoms). The hydrophobic compound may modify the surface to be hydrophobic without degrading the performance of the sulfide solid electrolyte particle, thereby significantly lowering the reactivity with moisture and improving the physical and chemical stability of the sulfide solid electrolyte particle. The solid electrolyte may be expressed as a surface-modified solid electrolyte, a solid electrolyte doped with a hydrophobic compound, a coated solid electrolyte, or the like.

The hydrophobic compound may be physically contacting or chemically bonded to the surface of the sulfide solid electrolyte particle. In addition, the hydrophobic compound may cover a portion of the surface of the sulfide solid electrolyte particle or may cover the whole surface thereof. The solid electrolyte include the sulfide solid electrolyte particle and a coating layer disposed on the surface of the particle and containing a hydrophobic compound. In this case, the coating layer may be in the form of an island or a film covering the entire particle surface.

The hydrophobic compound may include a fluoroalkyl group. The fluoroalkyl group may be a major group exhibiting hydrophobicity. The fluoroalkyl group may be substituted with 3 to 13 fluorine groups, for example, 5 to 13, 7 to 13, or 9 to 13 fluorine groups. In this case, the hydrophobic compound may exhibit strong hydrophobicity, reduce reactivity with moisture and improve structural stability without reducing physical properties such as ionic conductivity of the solid electrolyte, thereby contributing to improving the performance of an all-solid-state battery.

The number of carbon atoms in the fluoroalkyl group may be 1 to 25, for example, 2 to 20, 3 to 18, 4 to 16, 5 to 14, 5 to 12, or 6 to 10. The hydrophobic compound may exhibit strong hydrophobicity on the surface of the sulfide solid electrolyte particle and may effectively prevent a reaction with moisture.

The hydrophobic compound may further include other functional groups in addition to the fluoroalkyl group. For example, the hydrophobic compound may further include a linker group linking the sulfide solid electrolyte particle and the fluoroalkyl group. In this case, in the hydrophobic compound, the linker group may be a moiety bonding to the sulfide solid electrolyte particle, and the fluoroalkyl group may be a moiety exhibiting hydrophobicity in the outermost shell.

The linker group may contain, for example, a functional group having at least one lone pair of electrons. This functional group may serve to bind to the sulfide solid electrolyte particle. The functional group having at least one lone pair of electrons may have, for example, one to three or one or two lone pairs. The functional group having at least one lone pair of electrons may be, for example, —OR¹, —NR²R³, —SR⁴, or a combination thereof. Herein R¹, R², R³, and R⁴ are each independently hydrogen or a substituted or unsubstituted C1 to C20 alkyl group. The terms “C1 to C20” refers to the number of carbon atoms in the alkyl group. The alkyl group may be, for example, a C1 to C16 alkyl group, a C1 to C10 alkyl group, a C1 to C6 alkyl group, a C1 to C5 alkyl group, or a C1 to C3 alkyl group. The functional group having at least one lone pair of electrons may be, for example, —OH, —NH₂, —SH, or a combination thereof.

As an example, the hydrophobic compound may be represented by Chemical Formula 1.

(X)ₐ—(Y)_{b}—(Z)_{c} [Chemical Formula 1]

In Chemical Formula 1, X is R¹O—, R²R³N—, or R⁴S—, wherein R¹, R², R³, and R⁴ are each independently hydrogen, or a substituted or unsubstituted C1 to C20 alkyl group, and 1≤a≤10. Y is a metal oxide, a metal hydroxide, a silyl group, an alkoxysilyl group, an organic group, or a combination thereof, and 0≤b≤3. Z is —(CH₂)_{d}—(CF₂)ₑ—CF₃, where 1≤d≤6, 0≤e≤5, and 1≤c≤3.

In Chemical Formula 1, X and Y may be a type of linker group, and Z may be a hydrophobic group.

X may represent a functional group containing at least one lone pair of electrons. The C1 to C20 alkyl group in the definitions of R¹, R², R³, and R⁴ may be, for example, a C1 to C16 alkyl group, a C1 to C10 alkyl group, a C1 to C6 alkyl group, or a C1 to C3 alkyl group. For example, X may be —OH, —NH₂, or —SH. In Chemical Formula 1, a may be, for example, 2≤a≤9, or 3≤a≤8. X may be a group that physically contacts or is chemically bonded to the surface of the sulfide solid electrolyte particle. The X moiety may stably and strongly contact or bond to the surface of the sulfide solid electrolyte particle. Accordingly, the surface of the sulfide solid electrolyte particle may be hydrophobically modified to suppress reactivity with moisture and improve physical and chemical stability.

The Y may be understood as a group that may be present in the hydrophobic compound in addition to the lone pair-containing functional group (X) and the fluoroalkyl group (Z). The Y may be hydrophobic by itself, may serve as a base to which the lone pair-containing functional group (X) and the fluoroalkyl group (Z) are stably bonded, and may play a role of linking the lone pair-containing functional group (X) and the fluoroalkyl group (Z).

Among the examples of Y, in the metal oxide and metal hydroxide, the metal may include, for example, Al, Ca, Ce, Co, Cr, Fe, Mg, Mn, Mo, Nb, Sr, Ti, V, W, Zr, or a combination thereof. Since Y is one group included in Chemical Formula 1, the metal oxide, metal hydroxide, etc. may have a complex structure in Chemical Formula 1.

The silyl group in Y may be, for example, represented by —SiR⁴R⁵—, wherein R⁴ and R⁵ may each independently be a substituted or unsubstituted C1 to C20 alkyl group.

The alkoxysilyl group in Y may be, for example, represented by —Si(OR⁶)(OR⁷)—, where R⁶ and R⁷ may each independently be a substituted or unsubstituted C1 to C20 alkyl group.

In Y, the organic group may be a functional group containing carbon. The functional group may be, for example, an alkyl group, an aryl group, an alkoxy group, a carbonyl group, a carboxyl group, or the like.

In Y, the metal oxide, metal hydroxide, silyl group, alkoxysilyl group, or organic group may be complexed. In Y, b may also be 0≤b≤1, or 1≤b≤2. Y may include, for example, a metal oxide, an alkoxysilyl group, or a combination thereof.

Z may have strong hydrophobicity as a fluoroalkyl group substituted with 3 to 13 fluorine groups, and may serve to suppress the reactivity of the sulfide solid electrolyte particle with moisture. In Z, for example, 1≤d≤5, or 2≤d≤4, and 1≤e≤5, 2≤e≤5, or 3≤e≤5. In Z, c may also be 1≤c≤2, and the like.

The hydrophobic compound may be included in an amount of about 1 part by weight to about 60 parts by weight, or, for example, about 5 parts by weight to about 55 parts by weight, about 10 parts by weight to about 50 parts by weight, about 15 parts by weight to about 45 parts by weight, or about 20 parts by weight to about 40 parts by weight based on 100 parts by weight of the sulfide solid electrolyte particle. In this case, the surface of the solid electrolyte containing the hydrophobic compound may be modified to be hydrophobic without deterioration of physical properties, so that the reactivity with moisture may be significantly reduced, and physical and chemical stability may be maintained, thereby improving the initial efficiency and cycle-life characteristics of the all-solid-state battery.

The sulfide solid electrolyte particle may include, for example, Li₂S—P₂S₅, Li₂S—P₂S₅—LiX (X is a halogen element, for example I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are integers and Z is Ge, Zn or Ga), Li₂S—GeS₂, Li₂S—SiS₂—Li₃PO₄, Li₂S—SiS₂-LiₚMO_{q} (p and q are integers and M is P, Si, Ge, B, Al, Ga, or In), or a combination thereof.

The sulfide solid electrolyte particle may be obtained by, for example, mixing Li₂S and P₂S₅ in a molar ratio of about 50:50 to about 90:10 or about 50:50 to about 80:20. In the above mixing ratio range, sulfide solid electrolyte particles having excellent ionic conductivity may be prepared. In addition, SiS₂, GeS₂, B₂S₃, etc. may be further included as other components to further improve ionic conductivity. As a mixing method, mechanical milling or a solution method may be applied. Mechanical milling is a method in which the starting materials and the ball are put in the reactor and stirred vigorously to micronize the starting materials to mix them. When the solution method is used, a solid electrolyte may be obtained as a precipitate by mixing the starting materials in a solvent. In addition, calcining may be additionally performed after mixing. When additional calcining is performed, crystals of the solid electrolyte may become more rigid.

For example, the sulfide solid electrolyte particles may include an argyrodite-type sulfide. The argyrodite-type sulfide may be, for example, LiₐM_{b}P_{c}S_{d}A_{c} (a, b, c, d and e are all 0 or more and 12 or less, M is Ge, Sn, Si or a combination thereof, and A is F, Cl, Br, or I), and specifically Li₃PS₄, Li₇P₃S₁₁, Li₆PS₅Cl, Li₆PS₅Br, Li₆PS₅I, and the like. These argyrodite-type sulfides have high ionic conductivity close to the ionic conductivity of 10⁻⁴ to 10⁻² S/cm, which is the ionic conductivity of general liquid electrolytes at room temperature. Thus, a close bond with the positive active material and the like may be formed without causing a decrease in ionic conductivity. Further, a close interface between the electrode layer and the solid electrolyte layer may be formed. In an all-solid-state battery including the same, battery performance such as rate capability, coulombic efficiency, and cycle-life characteristics may be improved.

The sulfide solid electrolyte particle may be amorphous or crystalline, and may be in a mixed state.

An average particle diameter (D50) of the sulfide solid electrolyte particle may be less than or equal to about 5.0 μm, for example, about 0.1 μm to about 5.0 μm, about 0.5 μm to about 5.0 μm, about 0.5 μm to about 4.0 μm, about 0.5 μm to about 3.0 μm, about 0.5 μm to about 2.0 μm, or about 0.5 μm to about 1.0 μm. The sulfide solid electrolyte particle satisfying such a particle size range may effectively penetrate between the positive active materials, and have excellent contact properties with the positive active material and connectivity between the electrolyte particles. The term “average particle diameter” refers to a diameter (D50) of particles having a cumulative volume of 50 volume % in the particle size distribution that is obtained by measuring the size (diameter or length of the major axis) of about 20 particles at random in an optical micrograph.

Method of Preparing Solid Electrolyte

In an implementation, a method of preparing a solid electrolyte may include dry-mixing sulfide solid electrolyte particles and a hydrophobic compound containing a fluoroalkyl group substituted with 3 to 13 fluorine groups, followed by heat-treating the same, to obtain the aforementioned solid electrolyte.

Since the sulfide solid electrolyte particles and the hydrophobic compound are the same as described above, detailed descriptions thereof will be not be repeated.

If the sulfide solid electrolyte particles and the hydrophobic compound were to be wet-mixed and heat-treated to obtain a surface-modified solid electrolyte, ionic conductivity of the solid electrolyte may be sharply deteriorated and may fail in realizing a desired performance. On the contrary, when the sulfide solid electrolyte particles and the hydrophobic compound are dry-mixed and heat-treated as described in an implementation, the obtained solid electrolyte may exhibit equal or slightly lower ionic conductivity than before surface-modification, the solid electrolyte may be surface-modified to exhibit hydrophobicity without deteriorating the performance to lower reactivity with moisture and to improve structural stability and thereby, improve initial efficiency, cycle-life characteristics, and the like of the all-solid-state batteries.

The method of preparing the solid electrolyte may include mixing 100 parts by weight of the sulfide solid electrolyte particle and about 1 part by weight to about 60 parts by weight of the hydrophobic compound. For example, based on 100 parts by weight of the sulfide solid electrolyte particle, the hydrophobic compound may be mixed in an amount of about 5 parts by weight to about 55 parts by weight, about 10 parts by weight to about 50 parts by weight, about 15 parts by weight to about 45 parts by weight, or about 20 parts by weight to about 40 parts by weight. In this case, the reactivity with moisture may be effectively reduced by sufficiently modifying the surface to be hydrophobic without reducing the ionic conductivity of the solid electrolyte.

The heat treatment may be performed at, for example, about 60° C. to about 180° C., or, for example, about 70° C. to about 150° C. or about 80° C. to about 120° C. for about 30 minutes to about 8 hours or for about 1 hour to about 5 hours, but is not limited thereto.

All-Solid-State Battery

In an embodiment, provided is an all-solid-state battery including a positive electrode, a negative electrode, and a solid electrolyte layer between the positive electrode and the negative electrode. Herein, the solid electrolyte layer and/or the positive electrode may be characterized to include the aforementioned solid electrolyte. Such an all-solid-state battery may effectively prevent deterioration of the solid electrolyte due to moisture, so that excellent initial efficiency and cycle-life characteristics may be realized. The all-solid-state battery may be expressed as an all-solid-state rechargeable battery, an all-solid-state rechargeable lithium battery, or the like.

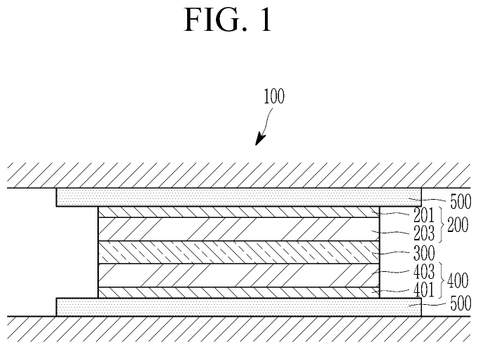

FIG. 1 illustrates a cross-sectional view of an all-solid-state battery according to an embodiment. Referring to FIG. 1, the all-solid-state battery 100 may have a structure in which an electrode assembly includes a negative electrode 400 that includes a negative current collector 401 and a negative active material layer 403; a solid electrolyte layer 300; and a positive electrode 200 including the positive active material layer 203 and a positive current collector 201, are stacked and may be accommodated in a case such as a pouch. Although a single electrode assembly including the negative electrode 400, the solid electrolyte layer 300, and the positive electrode 200 is illustrated in FIG. 1, in some implementations, an all-solid-state battery may be manufactured by stacking two or more electrode assemblies.

The all-solid-state battery 100 may further include an elastic sheet 500 on the outside of at least one of the positive electrode 200 and the negative electrode 400. The elastic sheet 500 may be expressed as a buffer layer or an elastic layer, and may uniformly transmit a pressure to the electrode laminate to keep the solid components in good contact and in addition, to relieve stress transferred to the solid electrolyte and the like and to suppress the generation of cracks in the solid electrolyte that could be due to the stress accumulated according to thickness changes of the electrodes during charging and discharging.

Positive Electrode

In the all-solid-state battery, a positive electrode may include a current collector and a positive material layer on the current collector. The positive material layer may include a positive active material and a solid electrolyte. The positive material layer may optionally include a binder and/or a conductive material. Herein, as a non-limiting example, the current collector may bean aluminum foil. The solid electrolyte included in the positive electrode may include the aforementioned surface-modified solid electrolyte. In this case, deterioration of the solid electrolyte due to moisture may be effectively suppressed, thereby improving cycle-life characteristics.

Positive Active Material

The positive active material may be a compound (for example, a lithiated intercalation compound) capable of reversibly intercalating and deintercallating lithium. Examples of the positive active material may include a compound represented by any one of the following chemical formulas:

LiₐA_{1-b}X_{b}D₂(0.90≤a≤1.8,0≤b≤0.5);

LiₐA_{1-b}X_{b}O_{2-c}D_{c}(0.90≤a≤1.8,0≤b≤0.5,0≤c≤0.05);

LiₐE_{1-b}X_{b}O_{2-c}D_{c}(0.90≤a≤1.8,0≤b≤0.5,0≤c≤0.05);

LiₐE_{2-b}X_{b}O_{2-c}D_{c}(0.90≤a≤1.8,0≤b≤0.5,0≤c≤0.05);

LiₐNi_{1-b-c}Co_{b}X_{c}D_{α}(0.90≤a≤1.8,0≤b≤0.5,0≤c≤0.5,0<α≤2);

LiₐNi_{1-b-c}Co_{b}X_{c}O_{2-α}T_{α}(0.90≤a≤1.8,0≤b≤0.5,0≤c≤0.05,0<α<2);

LiₐNi_{1-b-c}Co_{b}X_{c}O_{2-α}T₂(0.90≤a≤1.8,0≤b≤0.5,0≤c≤0.05,0<α<2);

LiₐNi_{1-b-c}Mn_{b}X_{c}D_{α}(0.90≤a≤1.8,0≤b≤0.5,0≤c≤0.05,0<α≤2);

LiₐNi_{1-b-c}Mn_{b}X_{c}O_{2-α}T_{α}(0.90≤a≤1.8,0≤b≤0.5,0≤c≤0.05,0<α<2);

LiₐNi_{1-b-c}Mn_{b}X_{c}O_{2-α}T₂(0.90≤a≤1.8,0≤b≤0.5,0≤c≤0.05,0<α<2);

LiₐNi_{b}E_{c}G_{d}O₂(0.90≤a≤1.8,0≤b≤0.9,0≤c≤0.5,0.001≤d≤0.1);

LiₐNi_{b}Co_{c}Mn_{d}GₑO₂(0.90≤a≤1.8,0≤b≤0.9,0≤c≤0.5,0≤d≤0.5,0.001≤e≤0.1);

LiₐNiG_{b}O₂(0.90≤a≤1.8,0.001≤b≤0.1);

LiₐCoG_{b}O₂(0.90≤a≤1.8,0.001≤b≤0.1);

LiₐMn_{1-b}G_{b}O₂(0.90≤a≤1.8,0.001≤b≤0.1);

LiₐMn₂G_{b}O₄(0.90≤a≤1.8,0.001≤b≤0.1);

LiₐMn_{1-g}G_{g}PO₄(0.90≤a≤1.8,0≤g≤0.5);

QO₂;QS₂;LiQS₂;

V₂O₅;LiV₂O₅;

LiZO₂;

LiNiVO₄;

Li_{(3-f)}J₂(PO₄)₃(0≤f≤2);

Li_{(3-f)}Fe₂(PO₄)₃(0≤f≤2);

LiₐFePO₄(0.90≤a≤1.8).

In the above chemical formulas, A may be selected from Ni, Co, Mn, and a combination thereof; X is selected from Al, Ni, Co, Mn, Cr, Fe, Mg, Sr, V, rare earth elements and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, or a combination thereof; Z is selected from Cr, V, Fe, Sc, Y, or a combination thereof; and J is selected from V, Cr, Mn, Co, Ni, Cu, or a combination thereof.

The positive active material may be a lithium-metal composite oxide, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), lithium manganese oxide (LMO), or lithium iron phosphate oxide (LFP).

The compounds described above may have a coating layer on the surface, or may be mixed with another compound having a coating layer. The coating layer may include at least one coating element compound selected from the group consisting of an oxide of a coating element, a hydroxide of a coating element, an oxyhydroxide of a coating element, an oxycarbonate of a coating element, and a hydroxyl carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a combination thereof. For example, the coating layer may include lithium zirconium oxide, for example Li₂O—ZrO₂. In the coating layer forming process, a method that does not adversely affect the physical properties of the positive active material, such as, for example, spray coating, dipping, and the like may be used.

The positive active material may include, for example, one or more of a lithium-metal composite oxide represented by Chemical Formula 11.

LiₐM¹¹_{1-y11-z11}M¹²_{y11}M¹³_{z11}O₂ [Chemical Formula 11]

In Chemical Formula 11, 0.9≤a≤1.8, 0≤y11≤1, 0≤z11≤1, 0≤y11+z11<1, M¹¹, M¹², and M¹³ are each independently at least one element selected from Ni, Co, Mn, Al, Mg, Ti, and Fe.

For example, M¹¹ may be Ni, and M¹² and M¹³ may each independently be a metal such as Co, Mn, Al, Mg, Ti, or Fe. In a specific embodiment, M¹¹ may be Ni, M¹² may be Co, and M¹³ may be Mn or Al, as non-limiting examples.

In an embodiment, the positive active material may include a lithium nickel-based composite oxide represented by Chemical Formula 12.

Liₐ₁₂Niₓ₁₂M¹⁴_{y12}M¹⁵_{1-x12-y12}O₂ [Chemical Formula 12]

In Chemical Formula 12, 0.9≤a12≤1.8, 0.3≤x12≤1, 0≤y12≤0.7, M¹⁴ and M¹⁵ are each independently at least one element selected from Al, B, Ba, Ca, Ce, Co, Cr, F, Fe, Mg, Mn, Mo, Nb, P, S, Si, Sr, Ti, V, W, and Zr.

The positive active material may include, for example, a lithium nickel cobalt-based oxide represented by Chemical Formula 13.

Liₐ₁₃Niₓ₁₃Co_{y13}M¹⁶_{1-x13-y13}O₂ [Chemical Formula 13]

In Chemical Formula 13, 0.9≤a13≤1.8, 0.3≤x13≤1, 0≤y13≤0.7, and M¹⁶ is at least one element selected from Al, B, Ba, Ca, Ce, Cr, F, Fe, Mg, Mn, Mo, Nb, P, S, Si, Sr, Ti, V, W, and Zr.

In Chemical Formula 13, 0.3≤x13≤0.99 and 0.01≤y13≤0.7, 0.4≤x13≤0.99 and 0.01≤y13≤0.6, or 0.5≤x13≤0.99 and 0.01≤y13≤0.5, or 0.6≤x13≤0.99 and 0.01≤y13≤0.4, or 0.7≤x13≤0.99 and 0.01≤y13≤0.3, 0.8≤x13≤0.99 and 0.01≤y13≤0.2, or 0.9≤x13≤0.99 and 0.01≤y13≤0.1.

In the lithium nickel-based composite oxide, a content of nickel may be greater than or equal to about 30 mol %. For example, the content of nickel may be greater than or equal to about 40 mol %, greater than or equal to about 50 mol %, greater than or equal to about 60 mol %, greater than or equal to about 70 mol %, greater than or equal to about 80 mol %, or greater than or equal to about 90 mol % and less than or equal to about 99.9 mol % or less than or equal to about 99 mol % based on the total amount of metals excluding lithium. For example, in the lithium nickel-based composite oxide, the content of nickel may be higher than the content of each of the other metals such as cobalt, manganese, aluminum, and the like. When the content of nickel satisfies the ranges, the positive active material may realize high capacity and exhibit excellent battery performance.

The positive active material may have an average particle diameter (D50) of about 1 μm to about 25 μm, for example about 4 μm to about 25 μm, about 5 μm to about 20 μm, about 8 μm to about 20 μm, or about 10 μm to about 18 μm. The positive active material having a particle diameter within the ranges may be harmoniously mixed with the other components in the positive active material layer and may realize high capacity and high energy density. The average particle diameter may be obtained by measuring the size of about 20 particles at random in an electron micrograph to obtain a particle size distribution, and taking the diameter (D50) of particles having a cumulative volume of 50 volume % from the particle size distribution as the average particle diameter.

The positive active material may be in the form of secondary particles formed through agglomeration of a plurality of primary particles or in the form of single particles. In addition, the positive active material may have a spherical shape or a shape close to the spherical shape or a polyhedral shape or an amorphous shape.

Based on the total weight of the positive active material layer, the positive active material may be included in an amount of about 55 wt % to about 99.7 wt %, or, for example, about 74 wt % to about 89.8 wt %. When the positive active material is included within the ranges, not only may the capacity of the all-solid-state be maximized, but also cycle-life characteristics thereof may be improved.

Solid Electrolyte

The positive electrode may include the aforementioned surface-modified solid electrolyte, and/or a non-surface-modified solid electrolyte. Since the solid electrolyte is the same as described above, a detailed description thereof will be not be repeated.

The positive electrode may further include an oxide-based inorganic solid electrolyte in addition to the aforementioned sulfide material. The oxide-based inorganic solid electrolyte may include, for example Li₁₊ₓTi₂₋ₓAl(PO₄)₃(LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃(PZT), Pb₁₋ₓLaₓZr_{1-y}Ti_{y}O₃(PLZT)(0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂(M=Te, Nb, or Zr; x is an integer of 1 to 10), or a mixture thereof.

Based on the total weight of the positive active material layer, the solid electrolyte may be included in an amount of about 0.1 wt % to about 35 wt %, for example about 1 wt % to about 35 wt %, about 5 wt % to about 30 wt %, about 8 wt % to about 25 wt %, or about 10 wt % to about 20 wt %. In addition, in the positive active material layer, based on the total weight of the positive active material and the solid electrolyte, the positive active material may be included in an amount of about 65 wt % to about 99 wt %, and the solid electrolyte may be included in an amount of about 1 wt % to about 35 wt %, and for example the positive active material may be included in an amount of about 80 wt % to about 90 wt %, and, for example, the solid electrolyte may be included in an amount of about 10 wt % to about 20 wt %. When the solid electrolyte is included in the positive electrode within the aforementioned contents, efficiency and cycle-life characteristics of the all-solid-state battery may be improved without deteriorating capacity.

Binder

The binder may serve to adhere positive active material particles to each other well and also to adhere the positive active material to the current collector. Examples of the binder may include polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, a vinylidenefluoride-hexafluoropropylene copolymer, polyethylene, polypropylene, a styrene butadiene rubber, an acrylated styrene butadiene rubber, a polyacrylonitrile, epoxy resin, nylon, poly(meth)acrylate, polymethyl(meth)acrylate, and the like, but are not limited thereto.

Among them, the binder according to an embodiment may include one or more selected from polyvinylidene fluoride, a vinylidene fluoride-hexafluoropropylene copolymer, polytetrafluoroethylene, a styrene butadiene rubber, polyacrylonitrile, and polymethyl (meth) acrylate. These binders may be dissolved well in the compound represented by Chemical Formula 1 and the compound represented by Chemical Formula 2 as a dispersion medium in the positive electrode composition. Thus, a uniform coating may be possible and excellent electrode plate performance may be realized.

The binder may be included in an amount of about 0.1 wt % to about 5 wt %, or about 0.1 wt % to about 3 wt %, based on the total weight of each component of the positive electrode for an all-solid-state battery or the total weight of the positive active material layer. In the above content range, the binder may sufficiently exhibit adhesive ability without degrading battery performance.

Conductive Material

The conductive material may be used to impart conductivity to the electrode. Any electronically conductive material that does not cause a chemical change may be used. The conductive material may be, for example, a carbon-based material such as natural graphite, artificial graphite, carbon black, acetylene black, ketjen black, a carbon fiber, a carbon nanofiber, or a carbon nanotube; a metal-based material containing copper, nickel, aluminum, silver and the like and in the form of a metal powder or a metal fiber; a conductive polymer such as a polyphenylene derivative, or a mixture thereof.

The conductive material may be included in an amount of about 0.1 wt % to about 5 wt %, or about 0.1 wt % to about 3 wt %, based on the total weight of each component of the positive electrode for an all-solid-state battery or the total weight of the positive active material layer. In the above content range, the conductive material may improve electrical conductivity without degrading battery performance.

The positive active material layer may include a conductive material in an amount of about 55 wt % to about 99.7 wt % of the positive active material; about 0.1 wt % to about 35 wt % of the solid electrolyte; about 0.1 wt % to about 5 wt % of the binder; and about 0.1 wt % to about 5 wt % of the conductive material based on the total weight of the positive active material, the solid electrolyte, the binder, and the conductive material. As a non-limiting specific example, about 74 wt % to about 89.8 wt % of the positive active material; about 10 wt % to about 20 wt % of the solid electrolyte; about 0.1 wt % to about 3 wt % of the binder; and about 0.1 wt % to about 3 wt % of the conductive material may be included. When mixed in the above content range, cycle-life characteristics of the battery may be improved while maximizing the capacity.

Negative Electrode

The negative electrode for an all-solid-state battery may include, for example, a current collector and a negative active material layer on the current collector. The negative active material layer may include a negative active material, and may further include a binder, a conductive material, and/or a solid electrolyte.

The negative active material may include a material capable of reversibly intercalating/deintercalating lithium ions, a lithium metal, an alloy of lithium metal, a material capable of doping and dedoping lithium, or a transition metal oxide.

The material that reversibly intercalates/deintercalates lithium ions may include, for example crystalline carbon, amorphous carbon, or a combination thereof as a carbon-based negative active material. The crystalline carbon may be non-shaped, or sheet, flake, spherical, or fiber shaped natural graphite or artificial graphite. The amorphous carbon may be a soft carbon, a hard carbon, a mesophase pitch carbonization product, calcined coke, and the like.

The lithium metal alloy may include an alloy of lithium and at least one metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative active material or a Sn-based negative active material. The Si-based negative active material may include silicon, a silicon-carbon composite, SiOₓ (0<x<2), a Si-Q alloy (wherein Q is an element selected from an alkali metal, an alkaline-earth metal, a Group 13 element, a Group 14 element, a Group 15 element, a Group 16 element, a transition metal, a rare earth element, and a combination thereof, but not Si), and the Sn-based negative active material may include Sn, SnO₂, a Sn—R alloy (wherein R is an element selected from an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, and a combination thereof.

The silicon-carbon composite may be, for example, a silicon-carbon composite including a core including crystalline carbon and silicon particles and an amorphous carbon coating layer disposed on the surface of the core. The crystalline carbon may be artificial graphite, natural graphite, or a combination thereof. The amorphous carbon precursor may be a coal-based pitch, mesophase pitch, petroleum-based pitch, coal-based oil, petroleum-based heavy oil, or a polymer resin such as a phenol resin, a furan resin, or a polyimide resin. In this case, the content of silicon may be about 10 wt % to about 50 wt % based on the total weight of the silicon-carbon composite. In some implementations, the content of the crystalline carbon may be about 10 wt % to about 70 wt % based on the total weight of the silicon-carbon composite, and the content of the amorphous carbon may be about 20 wt % to about 40 wt % based on the total weight of the silicon-carbon composite. In some implementations, a thickness of the amorphous carbon coating layer may be about 5 nm to about 100 nm.

An average particle diameter (D50) of the silicon particles may be about 10 nm to about 20 μm, for example about 10 nm to about 200 nm. The silicon particles may exist in an oxidized form. In this case, an atomic content ratio of Si:O in the silicon particles indicating a degree of oxidation may be a weight ratio of about 99:1 to about 33:67. The silicon particles may be SiOₓ particles. In this case, the range of x in SiOₓ may be greater than about 0 and less than about 2.

The Si-based negative active material or Sn-based negative active material may be mixed with the carbon-based negative active material. A mixing ratio of the Si-based negative active material or Sn-based negative active material and the carbon-based negative active material may be a weight ratio of about 1:99 to about 90:10.

In the negative active material layer, the negative active material may be included in an amount of about 95 wt % to about 99 wt % based on the total weight of the negative active material layer.

In an embodiment, the negative active material layer may further include a binder, and in some implementations may further include a conductive material. The content of the binder in the negative active material layer may be about 1 wt % to about 5 wt % based on the total weight of the negative active material layer. In some implementations, when the conductive material is further included, the negative active material layer may include about 90 wt % to about 98 wt % of the negative active material, about 1 wt % to about 5 wt % of the binder, and about 1 wt % to about 5 wt % of the conductive material.

The binder may serve to adhere the negative active material particles well to each other and also to adhere the negative active material to the current collector. The binder may be a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber binder or a polymer resin binder. The rubber binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethyleneoxide, polyvinylpyrrolidone, polyepichlorohydrine, polyphosphazene, polyacrylonitrile, an ethylenepropylenediene copolymer, polyvinylpyridine, chlorosulfonatedpolyethylene, latex, a polyester resin, an acrylic resin, a phenolic resin, an epoxy resin, polyvinyl alcohol, and a combination thereof.

When a water-soluble binder is used as the negative electrode binder, a cellulose-based compound capable of imparting viscosity may be further included. As the cellulose-based compound, one or more of carboxymethyl cellulose, hydroxypropylmethyl cellulose, methyl cellulose, or alkali metal salts thereof may be mixed and used. As the alkali metal, Na, K, or Li may be used. The amount of the thickener used may be about 0.1 parts by weight to about 3 parts by weight based on 100 parts by weight of the negative active material.

The conductive material may be included to provide electrode conductivity. Any electrically conductive material that does not cause a chemical change may be used as a conductive material. Examples of the conductive material may include, for example a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum silver, and the like; a conductive polymer such as a polyphenylene derivative, and the like; or a mixture thereof.

The negative current collector may be selected from a copper foil, a nickel foil, a stainless steel foil, a titanium foil, a nickel foam, a copper foam, a polymer substrate coated with a conductive metal, or a combination thereof.

Meanwhile, as an example, the negative electrode for an all-solid-state battery may be a precipitation-type negative electrode. The precipitation-type negative electrode does not have a negative active material when assembling a battery, but lithium metal is precipitated during charging of the battery, which provides a negative electrode serving as a negative active material.

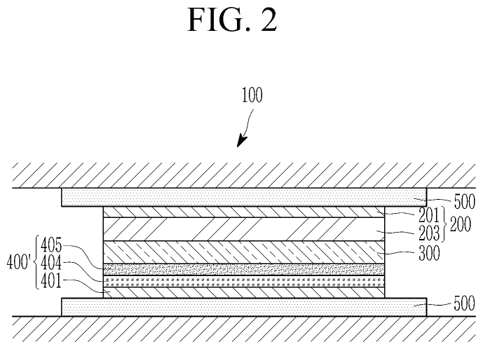

FIG. 2 is a schematic cross-sectional view of an all-solid-state battery including a precipitation-type negative electrode. Referring to FIG. 2, the precipitation-type negative electrode 400′ may include the current collector 401 and a negative electrode catalyst layer 405 disposed on the current collector. The all-solid-state battery having this precipitation-type negative electrode 400′ starts to be initially charged in absence of a negative active material. A lithium metal with high density and the like are precipitated between the current collector 401 and the negative electrode catalyst layer 405 during the charge and form a lithium metal layer 404, which may work as a negative active material. Accordingly, the precipitation-type negative electrode 400′, in the all-solid-state battery which is more than once charged, may include the current collector 401, the lithium metal layer 404 on the current collector, and the negative electrode catalyst layer 405 on the metal layer 404. The term “lithium metal layer 404” may refer to a layer on which lithium metal or the like is deposited during the charging process of the battery. The layer may be referred to as a metal layer or a negative active material layer.

The negative electrode catalyst layer 405 may include a metal and/or a carbon material that plays a role of a catalyst.

The metal may include, for example, gold, platinum, palladium, silicon, silver, aluminum, bismuth, tin, zinc, or a combination thereof, and may be composed of one selected therefrom or an alloy of more than one. An average particle diameter (D50) of the metal may be less than or equal to about 4 μm, for example about 10 nm to about 4 μm, about 10 nm to about 2 μm, or about 10 nm to about 1 μm.

The carbon material may be, for example, crystalline carbon, non-graphitic carbon, or a combination thereof. The crystalline carbon may be, for example, at least one selected from natural graphite, artificial graphite, mesophase carbon microbead, and a combination thereof. The non-graphite-based carbon may be at least one selected from carbon black, activated carbon, acetylene black, denka black, ketjen black, furnace black, graphene, or a combination thereof.

When the negative electrode catalyst layer 405 includes the metal and the carbon material, the metal and the carbon material may be mixed in a weight ratio of, for example, about 1:10 to about 1:2, about 1:10 to about 2:1, about 5:1 to about 1:1, or about 4:1 to about 2:1. In this case, the precipitation of the lithium metal may be effectively promoted and characteristics of the all-solid-state battery may be improved. The negative electrode catalyst layer 405 may include, for example, a carbon material on which a catalyst metal is supported or a mixture of metal particles and carbon material particles.

The negative electrode catalyst layer 405 may further include a binder. The binder may be, for example, a conductive binder. In some implementations, the negative electrode catalyst layer 405 may further include a general additive such as a filler, a dispersant, an ion conductive material, and the like.

A thickness of the negative electrode catalyst layer 405 may be, for example, about 1 μm to about 20 μm, about 2 μm to about 10 μm, or about 3 μm to about 7 μm. In some implementations, the thickness of the negative electrode catalyst layer 405 may be less than or equal to about 50%, less than or equal to about 20%, or less than or equal to about 5% of the thickness of the positive active material layer. When the thickness of the negative electrode catalyst layer 405 is too thin, the negative electrode catalyst layer 405 may be destroyed by the lithium metal layer 404. On the other hand, when the thickness of the negative electrode catalyst layer 405 is too thick, the density of the all-solid-state battery may be deteriorated, thereby increasing internal resistance.

The precipitation-type negative electrode 400′ may further include a thin film, on the surface of the current collector, for example, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or as an alloy of more than one element. The thin film may further planarize a precipitation shape of the lithium metal layer 404 and may greatly improve characteristics of the all-solid-state battery. The thin film may be formed, for example, by a vacuum deposition method, a sputtering method, a plating method, and the like. A thickness of the thin film may be for example about 1 nm to about 800 nm, or about 100 nm to about 500 nm.

The lithium metal layer 404 may include lithium metal or a lithium alloy. The lithium alloy may be, for example, a Li—Al alloy, a Li—Sn alloy, a Li—In alloy, a Li—Ag alloy, a Li—Au alloy, a Li—Zn alloy, a Li—Ge alloy, or a Li—Si alloy.

A thickness of the lithium metal layer 404 may be about 1 μm to about 500 μm, about 1 μm to about 200 μm, about 1 μm to about 100 μm, or about 1 μm to about 50 μm. When the lithium metal layer 404 is too thin, the lithium metal layer 404 may not work as a lithium reservoir, but when the lithium metal layer 404 is too thick, the battery volume may be increased, thereby deteriorating performance.

When such a precipitation-type negative electrode is applied, the negative electrode catalyst layer 405 may serve to protect the lithium metal layer 404 and suppress precipitation growth of lithium dendrites. Accordingly, a short circuit and capacity deterioration of the all-solid-state battery may be suppressed and cycle-life characteristics may be improved.

Solid Electrolyte Layer

The solid electrolyte layer 300 may include a solid electrolyte. The solid electrolyte may be the aforementioned surface-modified solid electrolyte, or may be or include a sulfide solid electrolyte, an oxide-based solid electrolyte, a solid polymer electrolyte, and the like, which are different from those described above. Since the solid electrolyte is the same as described above, a detailed description thereof will not be repeated.

The solid electrolyte layer may further include a binder in addition to the solid electrolyte. Herein, the binder may include a styrene butadiene rubber, polytetrafluoroethylene, polyvinylidene fluoride, polyethylene, an acrylate-based polymer, or a combination thereof, as non-limiting examples. The acrylate-based polymer may be, for example, butyl acrylate, polyacrylate, polymethacrylate, or a combination thereof.

The solid electrolyte layer may be formed by adding a solid electrolyte to a binder solution, coating the binder solution having the solid electrolyte added thereto onto a base film, and drying the resultant. The solvent of the binder solution may be isobutyryl isobutyrate, xylene, toluene, benzene, hexane, or a combination thereof, or the aforementioned compound represented by Chemical Formula 1 and/or compound represented by Chemical Formula 2. Since a forming process of the solid electrolyte layer is well known in the art, a detailed description thereof will not be repeated.

A thickness of the solid electrolyte layer may be, for example, about 10 μm to about 150 μm.

The solid electrolyte layer may further include an alkali metal salt, and/or an ionic liquid, and/or a conductive polymer.

The alkali metal salt may be, for example, a lithium salt. A content of the lithium salt in the solid electrolyte layer may be greater than or equal to about 1 M, for example, about 1 M to about 4 M. In this case, the lithium salt may improve ionic conductivity by improving lithium ion mobility of the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato) borate (LiBOB), lithium oxalyldifluoroborate (LIODFB), lithium difluoro(oxalato) borate (LiDFOB), lithium bis(trifluoromethanesulfonyl)imide (LiTFSI, LiN(SO₂CF₃)₂), lithium bis(fluorosulfonyl)imide, LiFSI, LiN(SO₂F)₂), LiCF₃SO₃, LiAsF₆, LiSbF₆, LiClO₄, or a mixture thereof.

In some implementations, the lithium salt may be an imide-based salt. For example, the imide-based lithium salt may be lithium bis(trifluoromethanesulfonyl) imide (LiTFSI, LiN(SO₂CF₃)₂), and lithium bis(fluorosulfonyl)imide (LiFSI, LiN(SO₂F)₂). The lithium salt may maintain or improve ionic conductivity by appropriately maintaining chemical reactivity with the ionic liquid.

The ionic liquid may have a melting point below room temperature. Thus, the ionic liquid may be in a liquid state at room temperature The ionic salt may be a salt or room temperature molten salt composed only of ions.

The ionic liquid may be a compound including at least one cation selected from a) ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based compound, and a mixture thereof, or b) at least one anion selected from BF₄—, PF₆—, AsF₆—, SbF₆—, AlCl₄—, HSO₄—, ClO₄—, CH₃SO₃—, CF₃CO₂—, C₁—, Br—, I—, BF₄—, SO₄—, CF₃SO₃—, (FSO₂)₂N—, (C₂F₅SO₂)2N—, (C₂F₅SO₂)(CF₃SO₂)N—, and (CF₃SO₂)₂N—.

The ionic liquid may be, for example, one selected from N-methyl-N-propylpyrrolidinium bis(trifluoromethanesulfonyl)imide, N-butyl-N-methylpyrrolidium bis(3-trifluoromethylsulfonyl) imide, 1-butyl-3-methylimidazolium bis(trifluoromethylsulfonyl)amide, 1-ethyl-3-methylimidazolium bis(trifluoromethylsulfonyl)amide.

In the solid electrolyte layer, the solid electrolyte and the ionic liquid may be used in a weight ratio of about 0.1:99.9 to about 90:10, for example, about 10:90 to about 90:10, about 20:80 to about 90:10, about 30:70 to about 90:10, about 40:60 to about 90:10, or about 50:50 to about 90:10. The solid electrolyte layer satisfying the above-described ranges may maintain or improve ionic conductivity by improving an electrochemical contact area with electrodes. Accordingly, energy density, discharge capacity, rate capability, and the like of the all-solid-state battery may be improved.

The all-solid-state battery according to an embodiment may be manufactured by sequentially stacking the positive electrode, the solid electrolyte, and the negative electrode and optionally adhering an elastic sheet onto the outer surface of the positive electrode and/or the negative electrode and compressing these. The compression may be performed for example at about 25° C. to about 90° C. under a pressure of less than or equal to about 550 MPa, less than or equal to about 500 MPa, or for example about 400 MPa to about 500 MPa. The compression may, for example, be provided by a isostatic press, roll press, or plate press.

The all-solid-state battery may be a unit battery having a structure of positive electrode/solid electrolyte layer/negative electrode, a bicell having a structure of positive electrode/solid electrolyte layer/negative electrode/solid electrolyte layer/positive electrode, or a stacked battery having a structure that the unit cells are repetitively stacked.

The shape of the all-solid-state battery is not particularly limited, and may be, for example, a coin type, a button type, a sheet type, a stack type, a cylindrical shape, a flat type, and the like. In addition, the all-solid-state battery may also be applied to a medium-to-large batteries used in electric vehicles and the like. For example, the all-solid-state battery may also be used in a hybrid vehicle such as a plug-in hybrid electric vehicle (PHEV). In addition, the all-solid-state battery may be applied to an energy storage system (ESS) storing a large amount of power and also to an electric bicycle, a power tool, or the like.

The following Examples and Comparative Examples are provided in order to highlight characteristics of one or more embodiments, but it is to be understood that the Examples and Comparative Examples are not to be construed as limiting the scope of the embodiments, nor are the Comparative Examples to be construed as being outside the scope of the embodiments. Further, it is to be understood that the embodiments are not limited to the particular details described in the Examples and Comparative Examples.

### Example 1

1. Preparation of Solid Electrolyte

0.2 g of argyrodite-type sulfide solid electrolyte particles (Li₆PS₅Cl, D50=3 μm) and 0.06 g of a hydrophobic fluoroalkyl-silyl-zirconia compound represented by Structural Formula 1 were dry-mixed at 100° C. for 3 hours with a lab mill and heat-treated, obtaining a solid electrolyte prepared by introducing the hydrophobic compound onto the surfaces of the sulfide solid electrolyte particles.

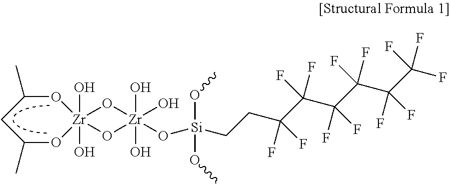

2. Manufacture of all-Solid-State Battery Cells

(1) Manufacture of Positive Electrode

A positive electrode composition was prepared by mixing 85 wt % of a LiNi_{0.8}Co_{0.15}Mn_{0.05}O₂ positive active material coated with Li₂O—ZrO₂, 13.5 wt % of the surface-modified solid electrolyte, 1.0 wt % of a polyvinylidene fluoride binder, and 0.5 wt % of a carbon nanotube conductive material. The prepared positive electrode composition was coated onto an aluminum positive electrode current collector with a bar coater and then, dried and compressed, manufacturing a positive electrode.

(2) Manufacture of Solid Electrolyte Layer

An acryl-based binder (SX-A334, Zeon Corp.) was dissolved in an isobutyl isobutyrate (IBIB) solvent to prepare a binder solution, and the surface-modified solid electrolyte was added thereto and then, stirred in a Thinky mixer to appropriately adjust viscosity. After adjusting the viscosity, 2 mm zirconia balls were added thereto and then, stirred again with the Thinky mixer, preparing slurry. In the slurry, 98.5 wt % of the solid electrolyte and 1.5 wt % of the binder were included. The slurry was coated onto a release PET film with a bar coater and dried at room temperature, forming a solid electrolyte layer.

(3) Manufacture of Negative Electrode

Carbon black having a primary particle diameter (D50) of about 30 nm and silver (Ag) having an average particle diameter (D50) of about 60 nm were mixed in a weight ratio of 3:1 to prepare a catalyst, and 0.25 g of the catalyst was added to 2 g of an NMP solution including 7 wt % of a polyvinylidene fluoride binder and then, mixed therewith, preparing a negative electrode catalyst layer composition. This composition was coated onto a nickel film current collector with a bar coater and vacuum-dried, preparing a precipitation-type negative electrode having a negative electrode catalyst layer on a current collector.

(4) Manufacture of all-Solid-State Battery Cell

The prepared positive electrode, solid electrolyte layer, and negative electrode were cut and stacked in an order of the positive electrode, the solid electrolyte layer, and the negative electrode, and an elastic sheet was laminated on the negative electrode. The obtained stack was sealed in the form of a pouch and compressed with a warm isostatic press (WIP) at a high temperature of 80° C. with 500 MPa for 30 minutes, manufacturing an all-solid-state battery cell. In the compressed state, the positive active material layer had a thickness of about 100 μm, the negative electrode catalyst layer has a thickness of about 7 μm, and the solid electrolyte layer had a thickness of about 60 μm.

### Example 2

A solid electrolyte and all-solid-state battery cell was manufactured in the same manner as in Example 1 except that a compound represented by Structural Formula 2 was used as the hydrophobic compound to prepare the solid electrolyte.

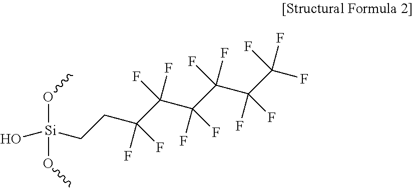

### Comparative Example 1

An all-solid-state battery cell was manufactured in the same manner as in Example 1 except that non-surface-modified argyrodite-type sulfide solid electrolyte particles (Li₆PS₅Cl, D50=3 μm) were used as the solid electrolyte.

### Comparative Example 2

A solid electrolyte was prepared by mixing sulfide solid electrolyte particles and a hydrophobic compound represented by Structural Formula 1 in an n-butanol solvent (0.14 g), drying the mixture, and heat-treating it at 100° C. for 3 hours. An all-solid-state battery cell was manufactured in the same manner as in Example 1 except that this solid electrolyte was used for the positive electrode and the solid electrolyte layer.

### Comparative Example 3

A solid electrolyte was prepared by mixing sulfide solid electrolyte particles and a hydrophobic compound represented by Structural Formula 1 in a toluene solvent (0.14 g), drying the mixture, and heat-treating it at 100° C. for 3 hours. An all-solid-state battery cell was manufactured in the same manner as in Example 1 except that this solid electrolyte was used for the positive electrode and the solid electrolyte layer.

### Evaluation Example: Ionic Conductivity Evaluation of Solid Electrolytes

The solid electrolytes of Example 1 and Comparative Examples 1 to 3 were measured with respect to resistance (R_{fresh}) and ionic conductivity (σ_{fresh}) and then, allowed to stand for 3 days at a dew point (T_{d}) of −45° C. for 3 days and then, measured again with respect to resistance (R_{3days}) and ion conductivity (σ_{days}). The results are shown in Table 1. In addition, a ratio of the ionic conductivity after allowed to stand for 3 days to the ionic conductivity before allowed to stand, that is, an ionic conductivity retention rate was calculated. The results are shown in Table 1.

TABLE 1

| | Ionic conductivity | | Ionic conductivity | | Ionic |
|---|---|---|---|---|---|
| | (before being | | (after being allowed | | Conductivity |
| | allowed to stand) | | to stand for 3 days) | | retention rate |
| | Rfresh | σ_{fresh} | R_{3days} | σ_{3days} | σ_{3days}/σ_{fresh} |
| | (Ω) | (mS/cm) | (Ω) | (mS/cm) | (%) |
| Example 1 | 107 | 0.75 | 226 | 0.36 | 48.0 |
| Comparative | 77.7 | 0.99 | 166 | 0.49 | 49.5 |
| Example 1 | | | | | |
| Comparative | — | — | — | — | — |
| Example 2 | | | | | |
| Comparative | 322 | 0.24 | — | — | — |
| Example 3 | | | | | |

Referring to Table 1, Example 1 exhibits an almost equal ionic conductivity retention rate to Comparative Example 1 having no surface treatment and even though the hydrophobic compound is introduced into the surface, realizes high ionic conductivity and ionic conductivity retention rate. On the other hand, Comparative Example 2, to which the wet coating was applied with a butanol solvent, was unmeasurable with respect to ionic conductivity due to some decomposition reaction, and Comparative Example 3, to which the wet coating was applied with a toluene solvent, exhibited very low ionic conductivity of 0.24 mS/cm and was unmeasurable with respect to ionic conductivity when allowed to stand for 3 days, which show that it was impossible for the composition of Comparative Example 3 to realize performance as a solid electrolyte.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

### DESCRIPTION OF SYMBOLS

100: all-solid-state battery
200: positive electrode
201: positive electrode current collector
203: positive active material layer
300: solid electrolyte layer
400: negative electrode
401: negative current collector
403: negative active material layer
400′: precipitation-type negative electrode
404: lithium metal layer
405: negative electrode catalyst layer
500: elastic layer

What is claimed is:

1. A solid electrolyte, comprising:
a sulfide solid electrolyte particle; and
a hydrophobic compound on a surface of the sulfide solid electrolyte particle,
wherein the hydrophobic compound includes a fluoroalkyl group substituted with 3 to 13 fluorine groups.

2. The solid electrolyte as claimed in claim 1, wherein the hydrophobic compound further includes a linker group containing a functional group having at least one lone pair of electrons.

3. The solid electrolyte as claimed in claim 2, wherein the functional group having at least one lone pair of electrons includes —OR¹, —NR²R³, —SR⁴, or a combination thereof, in which R¹, R², R³, and R⁴ are each independently hydrogen or a substituted or unsubstituted C1 to C20 alkyl group.

4. The solid electrolyte as claimed in claim 2, wherein the functional group having at least one lone pair of electrons is in contact with or bonded to the surface of the sulfide solid electrolyte particle.

5. The solid electrolyte as claimed in claim 1, wherein
the hydrophobic compound is represented by Chemical Formula 1:
(X)ₐ—(Y)_{b}—(Z)_{c} [Chemical Formula 1]
in Chemical Formula 1,
X is R¹O—, R²R³N—, or R⁴S—, wherein R¹, R², R³, and R⁴ are each independently hydrogen, or a substituted or unsubstituted C1 to C20 alkyl group,
Y is a metal oxide, a metal hydroxide, a silyl group, an alkoxysilyl group, an organic group, or a combination thereof,
Z is —(CH₂)_{d}—(CF₂)ₑ—CF₃, and
1≤a≤10, 0≤b≤3, 1≤c≤3, 1≤d≤6, and 0≤e≤5.

6. The solid electrolyte as claimed in claim 5, wherein in Chemical Formula 1, X is HO—, H₂N—, or HS—.

7. The solid electrolyte as claimed in claim 5, wherein, in Chemical Formula 1,
Y is a metal oxide, an alkoxysilyl group, or a combination thereof, and
1≤b≤3.

8. The solid electrolyte as claimed in claim 1, wherein the hydrophobic compound covers a portion or the whole of the surface of the sulfide solid electrolyte particle.

9. The solid electrolyte as claimed in claim 1, wherein the hydrophobic compound is included in an amount of about 1 part by weight to about 60 parts by weight based on 100 parts by weight of the sulfide solid electrolyte particle.

10. The solid electrolyte as claimed in claim 1, wherein
the sulfide solid electrolyte particle includes Li₂S—P₂S₅, Li₂S—P₂S₅LiX, in which X is a halogen element, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ, in which m and n are each an integer, and Z is Ge, Zn, or Ga, Li₂S—GeS₂, Li₂S—SiS₂—Li₃PO₄, Li₂S—SiS₂-LiₚMO_{q}, in which p and q are integers and M is P, Si, Ge, B, Al, Ga or In, or a combination thereof, or a combination thereof.

11. The solid electrolyte as claimed in claim 1, wherein the sulfide solid electrolyte particle includes an argyrodite-type sulfide.

12. The solid electrolyte as claimed in claim 1, wherein an average particle diameter (D50) of the sulfide solid electrolyte particles is about 0.5 μm to about 5.0 μm.

13. A method of preparing the solid electrolyte as claimed in claim 1, the method comprising:
dry-mixing a sulfide solid electrolyte particle and a hydrophobic compound containing a fluoroalkyl group substituted with 3 to 13 fluorine to obtain a mixture; and
heat-treating the mixture.

14. The method as claimed in claim 13, wherein the dry-mixing includes dry-mixing:
100 parts by weight of the sulfide solid electrolyte particle; and
about 1 part by weight to about 60 parts by weight of the hydrophobic compound containing a fluoroalkyl group substituted with 3 to 13 fluorine.

15. The method as claimed in claim 13, wherein the heat-treating is performed at a temperature of about 60° C. to about 180° C. for about 30 minutes to about 8 hours.

16. An all-solid-state battery, comprising:
a positive electrode,
a negative electrode, and
a solid electrolyte layer between the positive electrode and the negative electrode,
wherein the positive electrode or solid electrolyte layer includes the solid electrolyte as claimed in claim 1.
